(19) United States
(12) Patent Application Publication
(10) Pub. No.: US 2009/0276432 A1
(43) Pub. Date: Nov. 5, 2009

(54) DATA FILE STORING MULTIPLE DATA TYPES WITH CONTROLLED DATA ACCESS

(76) Inventors: Erdem Hokenek, Yorktown Heights, NY (US); Mayan Moudgill, White Plains, NY (US); C. John Glossner, Carmel, NY (US); Michael J. Schulte, Madison, WI (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/718,607

(22) PCT Filed: Nov. 15, 2005
(86) PCT No.: PCT/US05/41419

§ 371 Date: Sep. 25, 2008

Related U.S. Application Data
(60) Provisional application No. 60/628,647, filed on Nov. 17, 2004.

(51) Int. Cl. G06F 17/30

(52) U.S. Cl. 707/9; 707/E17.01

(57) ABSTRACT

A method and apparatus for efficiently storing multiple data types in a computer's register or data file. A single data file can store data with a variety of sizes and number formats, including integers, fractions, and mixed numbers. The register file is partitioned into fields, such that only the relevant portions of the register file are read or written.

### BACKGROUND AND SUMMARY OF THE INVENTION

The present disclosure is directed to digital processors and more specifically to data files of the processors which are capable of storing different data types.

Almost all programmable digital processors use register files to store data on the processor. See J. L. Hennessy and D. A. Patterson, Computer Architecture: A Quantitative Approach, Third Edition, Morgan Kaufmann Publishes, 2003. On most processors, integer registers file with n-bit registers can store integer data types with sizes less than or equal to n. However, on these processors, the smaller data types are accessed using the same mechanism as the larger data type (i.e., all n bits of data are read or written). Thus, no power savings is achieved for the smaller data types. Some register files store both integer and floating-point data types. See V. Y. Gorshtein and O. A. Efremova, “Method and Apparatus for Conflict-Free Execution of Integer and Floating-Point Operations with a Common Register File,” and U.S. Pat. No. 6,668,316, Dec. 23, 2003. However, these register files do not reduce power dissipation by allowing only certain portions of the register file to be accessed based on the operand data type

Instruction set processors typically provide support for a wide variety of data types. On instruction set processors for digital signal processing and multimedia applications, common data types include integers, fractions, and mixed numbers. These data-types are referred to as fixed-point, since the b y point is in a fixed position. Data types typically come in a variety of sizes (e.g., 8, 16, 32, 40, or 64 bits). Data types with larger sizes can be used to represent a larger range of number or numbers with more accuracy, but they require more storage and larger function units. Data types with smaller sizes require less storage and smaller functional units, but do not provide as much range or accuracy.

FIG. 1 shows a variety of data types. The top two data types correspond to integers, the next two data types correspond to fractions, and the bottom two data types correspond to mixed numbers. In FIG. 1, the least significant bit of the number is on the right and the most significant bit is on the left. With integers, all of the bits of the number are to the left of the binary point. Unsigned n-bit integers have a range from 0 to 2ⁿ⁻¹ and two's complement n-bit integers have a range from −2ⁿ⁻¹ to 2ⁿ⁻¹−1. With unsigned fractions, all of the bits of the number are to the right of the binary point, while with two's complement fractions (not shown in FIG. 1) there is a sign bit to the left of the binary point and the rest of the bits are to the right of the binary point. Unsigned n-bit fractions have a range from 0 to 1-2ⁿ and two's complement n-bit fractions have a range from −1 to 1-2ⁿ⁻¹. Mixed numbers have integer bits to the left of the binary point and fraction bits to the right of the binary point. An unsigned mixed with i integer bits and (n−i) fraction bits has a range from 0 to 2ⁱ-2⁻ⁿ⁺ⁱ, and a two's complement mixed number has a range from −2ⁱ⁻¹ to 2ⁱ⁻¹-2⁻ⁿ⁺ⁱ⁻¹.

In FIG. 1, each type of number is shown with a longer data type and a shorter data type. In practice, there may be more than two sizes for each type of number. On instruction set processors, different data types maybe stored in different register files. For example, on general-purpose processors integer and floating-point data types typically have separate register files. This approach, however, typically increases the area and power consumption of the processor, and may also degrade performance. Another alternative is to store all data types in the same register file. In this case, however, the processor typically reads from and writes to the register file using the largest available data type, which may consume a large amount of power. For example, if the largest data type available is 32 bits, the size of each register in the register file is 32 bits. 16-bit and 8-bit data types also use the same 32-bit registers and all access to the register file are for 32 bits, regardless of the data type.

In instruction set processors, data is typically stored in one or more register files. See D. A. Patterson and A. L. Hennessy, Computer Organization & Design: The Hardware/Software Interface, Second Edition, Morgan Kaufmann Publishers, 1998. FIG. 2 shows a register file with one combined read/write port k address bits, and n data bits. This register file stores a total of 2^{k}×n bits of data as 2^{k} n-bit registers. The n data bits correspond to the data that is read from or written to the register file. The k address bits indicate the location of the register to be accessed. The enable control signal indicates if the register file should be enabled. The read/write control signal indicates whether the register file should be read or written. The address to the register file is decoded and is used in conjunction with the enable and read/write control signals to determine if a particular register file should be read or written. Register file implementations typically vary based on the number of registers, the size of the registers, the number of read and write ports, and the type of control signals. See N. H. E. Weste and Kamran Eshraghian, Principals of CMOS VLSI Design: A Systems Perspective, Second Edition, AT&T, 1993.

With the present disclosed apparatus and method, a single register file can store a variety of data types including integers, fractions, and mixed numbers with different sizes. Compared to storing the different data types in different register files, this approach reduces area and power dissipation. To further reduce power dissipation, the register file can be partitioned into segments or fields, such that only the relevant portions of the register file are accessed (i.e., read or written) when a particular data type is accessed.

The present disclosure is a digital processor including a data file having n data bits and k address bits. The data file has a data port, an address port and at least one read/write port. The n data bits are divided into m fields; and m enable ports such that one or more fields can be enabled for each address. n may represent the number of bits of the maximum bit data type that the processor is designed to accommodate. The number of data bits nⱼ of the minimum field may equal the number of bits of the minimum bit data type that the processor is designed to accommodate. The number of data bits nⱼ of each field j is selected to accommodate a plurality of different data bit nⱼ data types when enabled individually or in combination.

The data file may be a register data file. The data file accommodates at least two of the following fixed point data types: integers, fractions and mixed numbers. The integer portion and the fraction portion of a mixed number are in two adjacent fields. Each field j has nⱼ data bits and only the number of fields necessary for a selected data type are enabled for each read/write operation.

The disclosure is also a method of operating a digital processor which includes a data file having n data bits divided into m fields, each field j has nⱼ data bits, and k address bits. The method includes addressing an entry in the data file; and enabling only the number of fields necessary for a selected data type for each read/write operation.

These and other aspects of the present invention will become apparent from the following detailed description of the invention, when considered in conjunction with the accompanying drawings.

### BRIEF DESCRIPTION OF THE DRAWINGS

FIG. 1 depicts a variety of common data types including integers, fractions, and mixed numbers with different sizes.

FIG. 2 depicts a conventional 2^{k}- word by n-bit register file with one read/write port.

FIG. 3 depicts a register partitioned into multiple fields according to the present disclosure.

FIG. 4 depicts a 64-bit register partitioned into four fields according to the present disclosure.

FIG. 5 depicts a 40-bit register partitioned into three fields according to the present disclosure.

FIG. 6 depicts a register file that is partitioned into multiple smaller register files, where each register can be enabled individually according to the present invention.

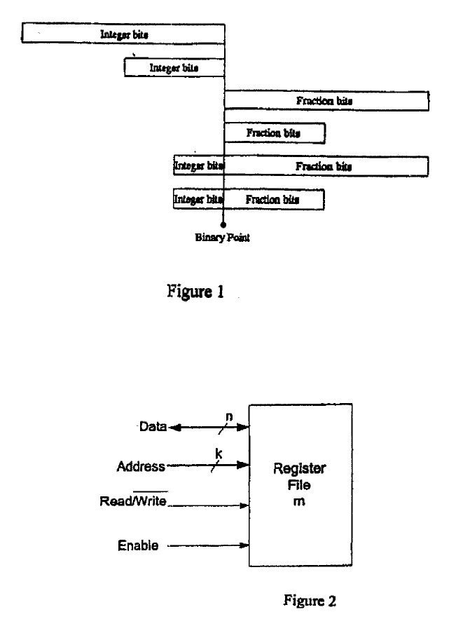

### DETAILED DESCRIPTION OF THE PREFERRED EMBODIMENTS

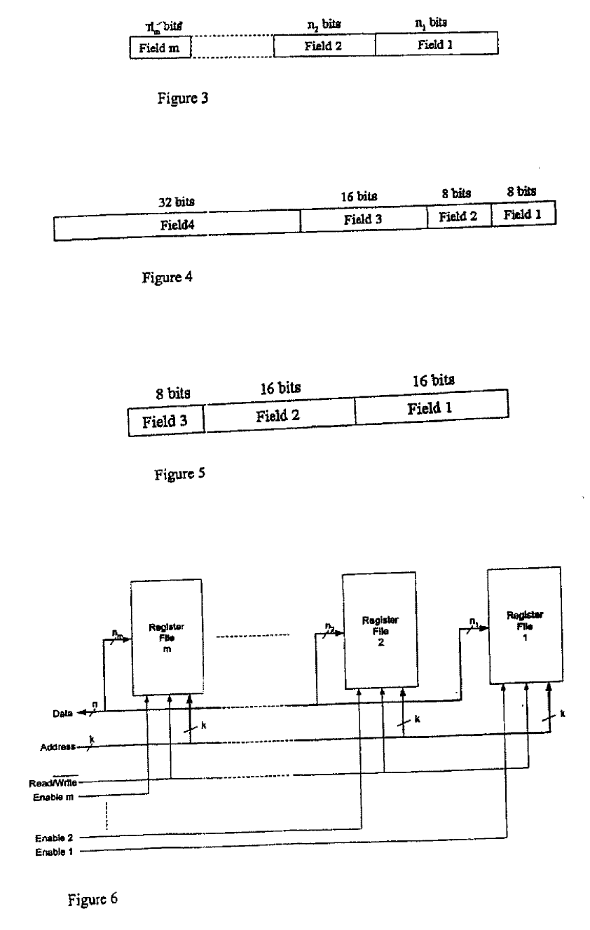

The invention is a method and apparatus for efficiently storing multiple data types in a computer's register or data file. Compared to previous techniques, a single register or data file is used to store multiple data types and only the necessary portions of the register file are read or written. One method for accomplishing this is illustrated in FIG. 3, which shows a single register within the register file that has been partitioned into multiple fields, where m denotes the total number of fields. Each of the fields can vary in size and there can be an arbitrary number of fields. The number of bits in Field j as denoted in nⱼ. The sum of the lengths of the fields (n₁+n₂+. . . n) should be as large as the largest data type to be stored in the register file. Furthermore, the registers should be partitioned such that each data type can be accessed (read or written) by accessing one or more fields.

As an example of the invention, consider a processor that supports 8-bit, 16-bit, 32-bit and 64-bit integers. Since the size of the largest data type is 64 bits, each register should also be 64 bits in order to store any data type. As shown in FIG. 4, each 64-bit register can be divided into four fields; two 8-bit fields, Field 1 and Field 2, one 16-bit field, Field 3, and one 32-bit field, Field 4 8-bit integers are stored in Field 1. 16-bit integers are stored in Fields 1 and 2. 32-bit integers are stored in Fields 1 trough 3. And 64-bit integers are stored in Fields 1 through 4. When accessing the register file for a particular data type, only the corresponding fields need to be enabled or accessed.

As a second example of the invention, consider a processor that supports 16-bit and 32-bit integers and fractions, and 24-bit and 40-bit mixed numbers with 8 integer bits. Since tie size of the largest data type is 40 bits, each register should also be 40 bits. As shown in FIG. 5, each 40-bit register can be divided into three fields; two 16-bit fields, Field 1 and Field 2, and one 8-bit field, Field 3. For integers, the binary point is to the right of Field 1. Thus, 16-bit integers are stored in Field 1 and 32-bit integers are stored in Fields 1 and 2. For the mixed numbers and fractions, the binary point is between Fields 2 and 3. Thus 16-bit fractions art stored in Field 2 and 32-bit fractions are stored in Fields 1 and 2. 24-bit mixed numbers are stored in Fields 2 and 3 and 40-bit mixed numbers are store in Fields 1 through 3.

FIG. 6 shows one possible implementation of tee proposed invention for a register file with one combined read/write port, k address bits, and n data bits. The same concept can easily be extended to register files with multiple read and write ports, or to another register file configurations. Similar to the register file shown in FIG. 2, the register file in FIG. 6 stores a total of 2^{k}×n bits. It is partitioned into m smaller register files, where register file j stores 2^{k}×nⱼ bits of data as 2^{k} nⱼ-bit registers. The register file is partitioned in the same manner as the individual registers, illustrated in FIG. 3. Register file j receives all of the address bits, the read/write signal, their own nⱼ bits of data, and their own enable signal. The enable signals are set based on the data type being accessed so that only the appropriate portions of the register file are read or written.

Although the present invention has been described and illustrated in detail for register files, it is to be clearly understood that this is done by way of illustration and example only and is not to be taken by way of limitation, the principles are also applicable to other data files. Although the number of data bits of nⱼ of the fields j are shown as integer multiples of each other, for example, 8, 16, 32, 64, other filed lengths maybe used. The scope of the present invention is to be limited only by the terms of the appended claims.

What is claimed:

1. A digital processor including a data file having n data bits and k address bits, the data file comprising
a data port, an address port and at least one read/write port
the n data bits being divided into m fields; and
m enable ports such that one or more fields can be enabled for each address.

2. The processor according to claim 1, wherein n represents the numb of bits of the maximum bit data type that the processor is designed to accommodate.

3. The processor according to claim 2, wherein the number of data bits nⱼ of the minimum field equals the number of bits of the minimum bit data type that the processor is designed to accommodate.

4. The processor according to claim 2, wherein the number of data bits nj of each field j is selected to accommodate a plurality of different data bit nj data types when enabled individually or in combination.

5. The processor according to claim 1, wherein the number of data bits nⱼ of each field j is selected to accommodate a plurality of different data bit nⱼ data types when enabled individually or in combination.

6. The processor according to claim 1, wherein the data file is a register data file.

7. The processor according to claim 1, wherein the data file accommodates at least two of the following fixed point data types: integers, fractions and mixed numbers.

8. The processor according to claim 7, wherein an integer and a fraction portion of a mixed number are in two adjacent fields.

9. The processor according to claim 1, wherein each field j has nⱼ data bits and only the number of fields necessary for a selected data type are enabled for each read/write operation.

10. A method of operating a digit processor which includes a data file having n data bits divided into m fields, each j has nⱼ data bits, and k address bits, the method comprising:
addressing an entry in the data file; and
enabling only the number of fields necessary for a selected data type for each read/write operation.

11. The method according to claim 10, including selecting n to be equal to the number of bits of the maximum bit data type that the processor is designed to accommodate.

12. The method according to claim 11, including selecting the number of data bits nⱼ of the minimum.

13. The method according to claim 11, including selecting the number of data bits nⱼ of each field j to accommodate a plurality of different data bit nⱼ data types when enabled individually or in combination.

14. The method according to claim 10, including selecting the number of data bits nⱼ of each field j to accommodate a plurality of different data bit n data types when enabled individually or in combination.

15. The method according to claim 10, wherein the data file is a register data file.

16. The method according to claim 10, wherein the data file accommodates at least two of the following fixed point data types: integers, fractions and mixed numbers.

17. The method according to claim 10, wherein an integer and a fraction portion of a mixed number are in two adjacent fields.
